(19) United States
(12) Patent Application Publication
(10) Pub. No.: US 2006/0067782 A1
(43) Pub. Date: Mar. 30, 2006

(54) Self-regulating container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/949,238

(22) Filed: Sep. 24, 2004

(51) Int. Cl. B43K 5/14; B43K 5/00

(52) U.S. Cl. 401/132; 401/205

(57) ABSTRACT

The self-regulating container is a container with a hygroscopic additive that will maintain the concentration and moisture of the content enclosed within it. The self-regulating container comprises of an elongated tube with a sealed end. A first substance is disposed within said elongated tube. A hygroscopic substance is added to the first substance. A second substance is disposed within said elongated tube sealing the first substance and the hygroscopic substance within the elongated tube. One or both ends of the elongated tube may be covered by an applicator such as a brush or an absorbent material such as cotton, foam, or sponge. The self-regulating container may be used to store and transport a substance for prolonged period of time and maintain a relatively consistent concentration and moisture content yet prevent evaporation of the substance.

### BACKGROUND

1. Field of Invention

The present invention relates generally to small containers. More specifically, the present invention relates to small tubular containers that encloses fluids.

2. Description of Related Art

Small containers are commonly used to hold liquids, creams, lotions, and powders. Fluids such as alcohol, medication, perfume, mouth wash, hand lotion, nail polish, eye-makeup remover, and various liquids as well as powder forms of various substances may be disposed in small containers of various configurations and sizes.

One such container is disclosed by Tsao in U.S. Pat. No. 5,702,035. Tsao discloses a tubular container with a sealed end and an applicator end with a liquid silicone stopper disposed therein. The small tubular container may be used to store, transport, and apply a variety of fluids.

However, one drawback with the liquid silicone stopper is that it is permeable. Furthermore, if the tubular container is made of a plastic material such as polypropylene, the walls of the tubular container is also permeable, although less so than the liquid silicone stopper. This means that the contents of the tubular container will slowly evaporate and lose water molecules. The water molecules in the contents of the tubular container will slowly evaporate through the liquid silicone stopper and the walls of the tubular container. This will limit the shelf-life of contents of the container. Furthermore, the composition of the contents of the container will slowly change over time as the water molecules evaporate from the content. This will change the concentration of the content of the container and result in stability problems with the contents of the container.

### BRIEF SUMMARY OF THE INVENTION

The self-regulating container is a container with a hygroscopic additive that will maintain the concentration and moisture of the content enclosed within it. An object of the present invention is to prolong the shelf life and effectiveness of the content within the container. Another object of the present invention is to provide a simple and economical single-dose container that can be used to store and transport small quantity of a substance such as a liquid. A further object of the present invention is to provide a container that can also be used as an applicator.

The self-regulating container comprises of an elongated tube with a sealed end. A first substance is disposed within said elongated tube. A hygroscopic substance is added to the first substance. A second substance is disposed within said elongated tube sealing the first substance and the hygroscopic substance within the elongated tube. One or both ends of the elongated tube may be covered by an absorbent material such as cotton, foam, or sponge. Alternatively, an applicator such as a brush may also be affixed to one or both ends of the elongated tube.

The self-regulating container may be used to store and transport a substance for prolonged period of time and maintain a relatively consistent concentration and moisture content yet prevent evaporation of the substance.

### BRIEF DESCRIPTION OF THE DRAWINGS

FIG. 1 shows the preferred embodiment of the self-regulating container.

FIG. 2 shows the preferred embodiment of the self-regulating container shown in FIG. 1 in its operating position.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

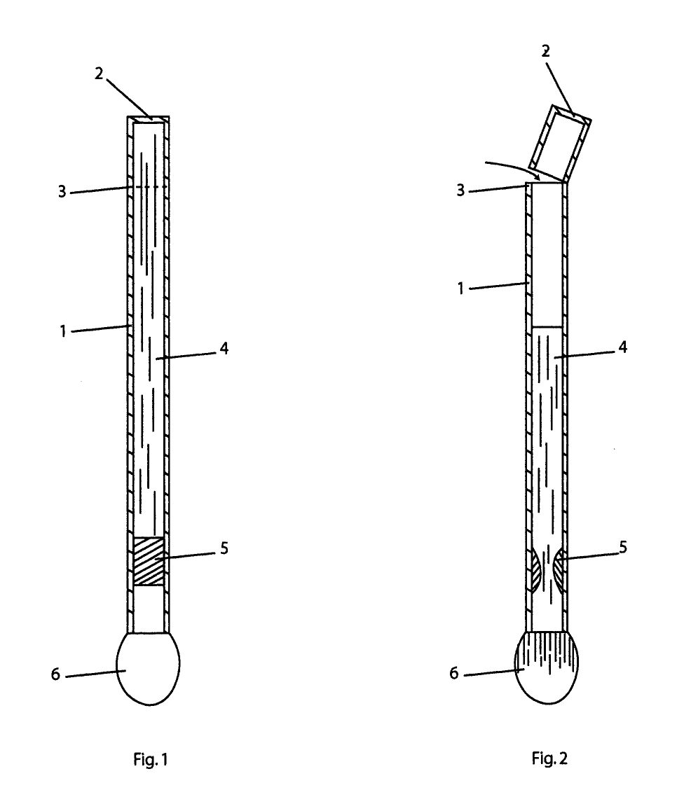

The self-regulating container is a container with a hygroscopic additive such as humectants that will maintain the concentration and moisture of the content enclosed within it. FIG. 1 shows the preferred embodiment of the self-regulating container. In the preferred embodiment, the self-regulating container comprises of an elongated tube 1 with a sealed end 2. In the preferred embodiment, the elongated tube 1 is made of polypropylene or polyethylene. Other suitable materials such as plastic may also be used for the elongated tube 1. In one embodiment, an opening means such as a fracture line 3 may be provided near the sealed end 2 of the elongated tube 1, as shown in FIG. 2. When the opening means is operated to allow air to enter near the sealed end 2 of the elongated tube 1, the contents of the elongated tube 1 may be released by the gravitational force.

A first substance 4 is disposed within the elongated tube 1. A hygroscopic substance such as humectants is added to the first substance 4. The humectants may be selected from the group consisting of glycerin, propylene glycol, sorbitol, butylenes glycol, hexylene glycol, acetamide MEA, sodium PCA, sodium carboxymethyl cellulose, carbomer, polyethylene glycol, glycerol, calcium sulfate, poly(vinyl acetate), or any other suitable and compatible humectants.

A second substance 5 is disposed within said elongated tube 1 sealing the first substance 4 and the hygroscopic substance within the elongated tube 1. In the preferred embodiment, the second substance 5 is silicone.

One or both ends of the elongated tube 1 may be covered by an absorbent material 6 such as cotton, foam, or sponge. Alternatively, an applicator such as a brush may also be affixed to the ends of the elongated tube 1.

As the moisture evaporates from the first substance 4, the hygroscopic substance will absorb and retain the moisture from the atmosphere and the immediate surrounding environment to effectively maintain an equilibrium of the moisture content in the container. The moisture content will therefore be stabilized and maintained at a predetermined ratio. The self-regulating container may be used to store and transport a substance for prolonged period of time and maintain a relatively consistent concentration and moisture content yet prevent evaporation of the substance.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A self-regulating container comprising:
an elongated tube with a sealed end;
a first substance is disposed within said elongated tube;
a hygroscopic substance is added to the first substance; and
a second substance is disposed within said elongated tube sealing the first substance and the hygroscopic substance within the elongated tube.

2. A self-regulating container as in claim 1, wherein an opening means is provided near said sealed end of said elongated tube.

3. A self-regulating container as in claim 2, wherein said opening means is a fracture line.

4. A self-regulating container as in claim 1, wherein an applicator tip is affixed to an end of said elongated tube.

5. A self-regulating container as in claim 4, wherein said applicator tip is selected from the group comprising cotton, foam, sponge, and brush.

6. A self-regulating container as in claim 2, wherein an applicator tip is affixed to an end of said elongated tube.

7. A self-regulating container as in claim 6, wherein said applicator tip is selected from the group comprising cotton, foam, sponge, and brush.

8. A self-regulating container as in claim 1, wherein said elongated tube is made of polypropylene.

9. A self-regulating container as in claim 1, wherein said elongated tube is made of polyethylene.

10. A self-regulating container as in claim 2, wherein said elongated tube is made of polypropylene.

11. A self-regulating container as in claim 2, wherein said elongated tube is made of polyethylene.

12. A self-regulating container as in claim 1, wherein said hygroscopic substance is selected from the group comprising propylene glycol, sorbitol, butylenes glycol, hexylene glycol, acetamide MEA, sodium PCA, sodium carboxymethyl cellulose, carbomer, polyethylene glycol, glycerol, calcium sulfate, and poly(vinyl acetate).

13. A self-regulating container as in claim 1, wherein said second substance is silicone.

14. A self-regulating container as in claim 2, wherein said hygroscopic substance is selected from the group comprising propylene glycol, sorbitol, butylenes glycol, hexylene glycol, acetamide MEA, sodium PCA, sodium carboxymethyl cellulose, carbomer, polyethylene glycol, glycerol, calcium sulfate, and poly(vinyl acetate).

15. A self-regulating container as in claim 2, wherein said second substance is silicone.

16. A self-regulating container as in claim 4, wherein said hygroscopic substance is selected from the group comprising propylene glycol, sorbitol, butylenes glycol, hexylene glycol, acetamide MEA, sodium PCA, sodium carboxymethyl cellulose, carbomer, polyethylene glycol, glycerol, calcium sulfate, and poly(vinyl acetate).

17. A self-regulating container as in claim 4, wherein said second substance is silicone.

18. A self-regulating container as in claim 6, wherein said hygroscopic substance is selected from the group comprising propylene glycol, sorbitol, butylenes glycol, hexylene glycol, acetamide MEA, sodium PCA, sodium carboxymethyl cellulose, carbomer, polyethylene glycol, glycerol, calcium sulfate, and poly(vinyl acetate).

19. A self-regulating container as in claim 6, wherein said second substance is silicone.
